(19) United States
(12) Patent Application Publication
(10) Pub. No.: US 2007/0297884 A1
(43) Pub. Date: Dec. 27, 2007

(54) Wafer receptacle in semiconductor device fabrication equipment

(76) Inventor: Hyun-Su Jung, Suwon-si (KR)

Correspondence Address: VOLENTINE & WHITT PLLC, ONE FREEDOM SQUARE, 11951 FREEDOM DRIVE SUITE 1260, RESTON, VA, 20190, US

(21) Appl. No.: 11/703,688

(22) Filed: Feb. 8, 2007

(30) Foreign Application Priority Data
Jun. 21, 2006 (KR) 2006-0055824

(51) Int. Cl. B65G 49/07

(52) U.S. Cl. 414/411

(57) ABSTRACT

A FOUP can be used either side up so that wafers can stand by with either of their major surfaces facing up. The body of the FOUP has first and second graspable members disposed at the top and bottom thereof, respectively. Each of the graspable members is configured to allow a transfer system of semiconductor device fabrication equipment to grasp the same and thereby transfer the FOUP. Likewise, the body of the FOUP has first and second support members disposed at the top and bottom thereof, respectively. Each of the support members can be fitted to the same portion of a load port of semiconductor device fabrication equipment. In addition, the body of the FOUP has door locking openings adjacent both the top and bottom thereof. The door of the FOUP has door locking members, and a key assembly that selectively moves the door locking members into and out of the door locking openings, respectively.

### BACKGROUND OF THE INVENTION

1. Field of the Invention

The present invention relates to semiconductor device fabrication. More particularly, the present invention relates to receptacles for holding wafers in semiconductor device fabrication equipment.

2. Description of the Related Art

Generally, a semiconductor device is fabricated by depositing various types of layers such as insulating layers and conductive layers on the surface of a wafer and patterning the deposited layers to form various geometrical circuit structures. More specifically, semiconductor devices are fabricated by subjecting a semiconductor substrate (wafer) to several individual processes including: an impurity ion implantation process of implanting 3B (for example, B) or 5B (for example, P or As) group impurity ions into the semiconductor substrate, a thin film deposition process of forming an insulating or conductive layer on the semiconductor substrate, an etching process of etching the insulating or conductive layer to pattern the layer, a deposition process of forming an interlayer insulating layer on the resultant structure, a chemical mechanical polishing (CMP) process of polishing the surface of the resultant structure to remove steps produced as a result of the forming of the interlayer insulating layer over the patterned layer, and a cleaning process of removing impurities from the substrate. These individual processes are repeatedly and selectively carried out to fabricate the final device. Twenty-five or fifty wafers, which are to be subjected to the fabrication processes, are kept in a wafer receptacle in a standby state. The wafers are transferred from the wafer receptacle into process chambers in which the fabrication processes are carried out.

An open wafer cassette has been generally used as such a receptacle when the wafers have a diameter of less than 8 inches. However, a front open unified pod (FOUP) has been used for 300 mm-diameter wafers. A FOUP is basically a closed receptacle and therefore prevents contamination of the wafers while the wafers are standing by. A FOUP typically comprises a FOUP body in which wafers are held, and a FOUP door for closing the FOUP body. The FOUP door is opened by a robot arm. FIG. 1 illustrates conventional FOUPs 14 disposed at a load port 10 of semiconductor device fabrication equipment. The FOUP is transferred to the semiconductor device fabrication equipment by a person guided vehicle (PGV) which is a passive transfer system, by an overhead transfer device (OHT), by an overhead conveyor (OHC) or by an automatic guided vehicle (AGV).

As illustrated in FIG. 1, the FOUP 14 is set on a plate 12 of the load port 10. Although not shown in the figure, a slotted wafer support is disposed inside the body of the FOUP 14, and a number of wafers are held within the slots of the wafer support, respectively. Once the FOUP 14 has been set on the plate 12 of the load port 10, the door of the FOUP 14 is opened by a robot arm (not shown) operating inside the load port 10. The load port 10 is typically connected to a load-lock chamber which, in turn, is connected to a process chamber in which a fabrication process such as the thin film deposition process or an etching process is carried out. Thus, wafers are transferred from the FOUP 14 to a process chamber/chambers, for example, where the wafers are subjected to a fabrication process/processes. The wafers are loaded back into a FOUP after one or more of the fabrication processes have been completed. The front door of the FOUP is closed once all of the processes performed by the semiconductor device fabrication equipment have been completed and the processed wafers have been loaded into the FOUP body.

However, a conventional FOUP must be loaded onto the load port 10 with a fixed orientation. That is, as illustrated in FIG. 1, the FOUP must be loaded onto the load port 10 with the top of the FOUP facing up. Accordingly, a machine is used to flip the wafers over when the disposition of the wafers needs to be changed for a particular process. However, these machines can be relatively expensive pieces of equipment, and require a lot of time for manipulating the wafers. Furthermore, these machines can scratch or break a portion of a wafer that is being held by the machine as the wafer is being manipulated.

### SUMMARY OF THE INVENTION

One object of the present invention is to provide a FOUP that minimizes the need to procure extra wafer ahndling equipment in the manufacturing of semiconductor devices or the like.

Another object of the present invention is to provide a FOUP that minimizes the chances that a wafer will be scratched or broken during its handling throughout the course of a manufacturing process.

According to one aspect of the present invention, there is provided a FOUP that allows the relative disposition of the major surfaces of wafers held by the FOUP to be changed easily. That is, the top and bottom of the FOUP are basically indistinguishable.

According to another aspect of the present invention, there is provided the combination of semiconductor device fabrication equipment having a load port at which semiconductor substrates stand by before and/or after being processed in the equipment, a transfer system for transporting the substrates to the load port, and a FOUP that can be transported by the transfer system and loaded on the load port without regard to which end of the FOUP is up.

A FOUP according to the present invention includes a FOUP body having graspable members and support members at its top and bottom, and a FOUP door. Each of the graspable members can be grasped by a transfer system. Thus, the FOUP can be transported by the transfer system with either the top or the bottom of the FOUP body facing upwardly. Each of the support members can be fitted to a portion of a load port. Thus, the FOUP can be stably supported on the load port with either the top or the bottom of the FOUP body facing upwardly. The FOUP door is fitted to the FOUP body at an open side thereof so as to cover the FOUP body. The FOUP door has a door body, at least one pair of first and second door locking members, and at least one key assembly for selectively moving the first and second door locking members into and out of the door locking openings of the FOUP body, respectively.

Preferably, the FOUP body has a frame delimiting the opening in the FOUP body at the open side thereof. The frame has upper and lower segments located adjacent the top and bottom of the FOUP body, respectively, and first and second ones of the door locking openings are defined in the upper and lower segments of the frame, respectively.

Preferably, each key assembly is supported in the body of the FOUP door so as to be rotatable. The key assembly is operatively connected to the first and second door locking members so as to slide the door locking members linearly when the at least one key assembly is rotated.

### BRIEF DESCRIPTION OF THE DRAWINGS

The above and other objects, features and advantages of the present invention will become more apparent to those of ordinary skill in the art by referring to the following detailed description of the preferred embodiments thereof made with reference to the attached drawings in which:

FIG. 1 illustrates a conventional FOUP disposed on a load port of typical semiconductor device fabrication equipment;

FIG. 2 is a perspective view of a FOUP according to the present invention, illustrating a state in which the door of the FOUP is opened;

FIG. 3 is another perspective view of the FOUP according to the present invention but showing a state in which the FOUP is upside down and the door of the FOUP is closed;

FIGS. 4A through 4C are front views of the door of the FOUP according to the present invention;

FIG. 5 is a front view of a frame of the body of the FOUP according to the present invention; and

FIG. 6 is a perspective view, from the rear, of the FOUP according to the present invention.

### DETAILED DESCRIPTION OF THE PREFERRED EMBODIMENTS

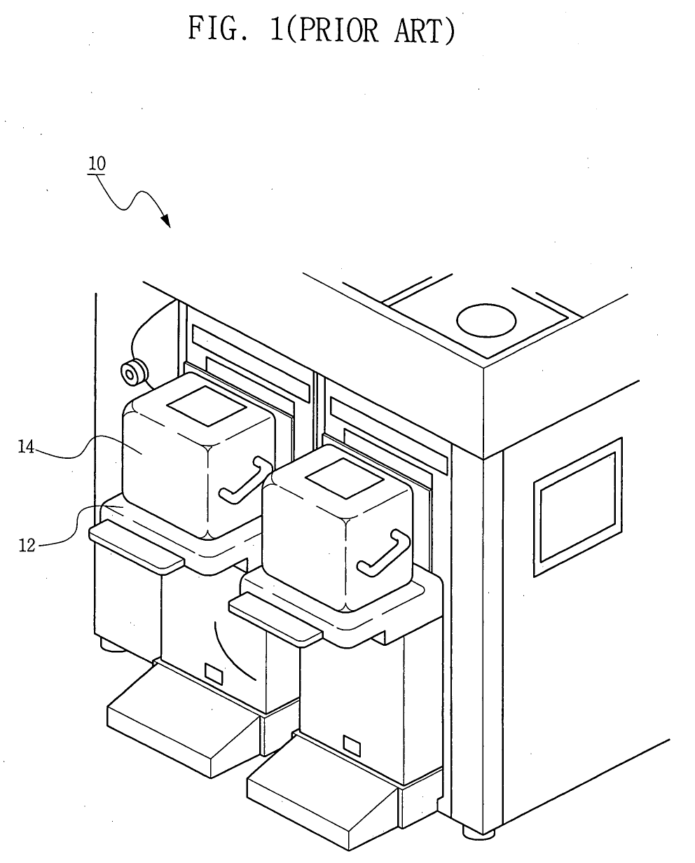

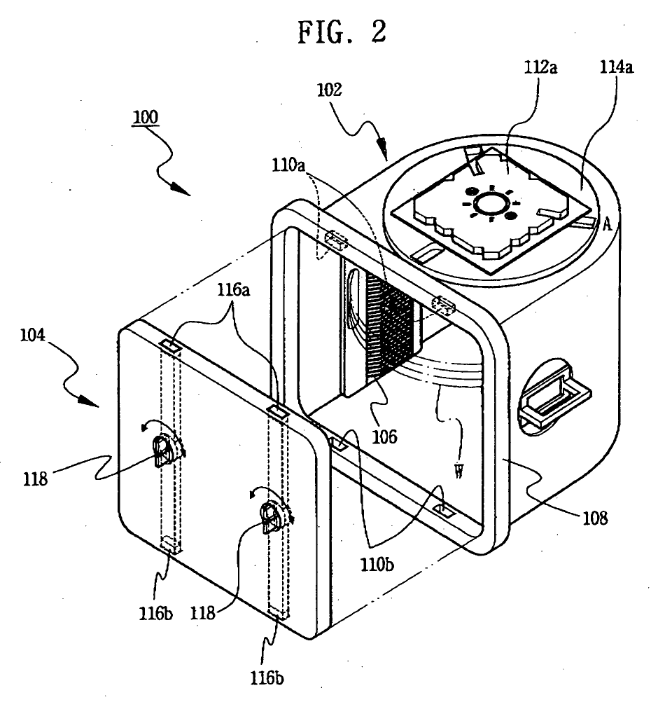

The present invention will now be described more fully hereinafter with reference to FIGS. 2-6. However, reference should be made back to FIG. 1 for the illustration of a load port to which the FOUP of the present invention can be transported and placed on.

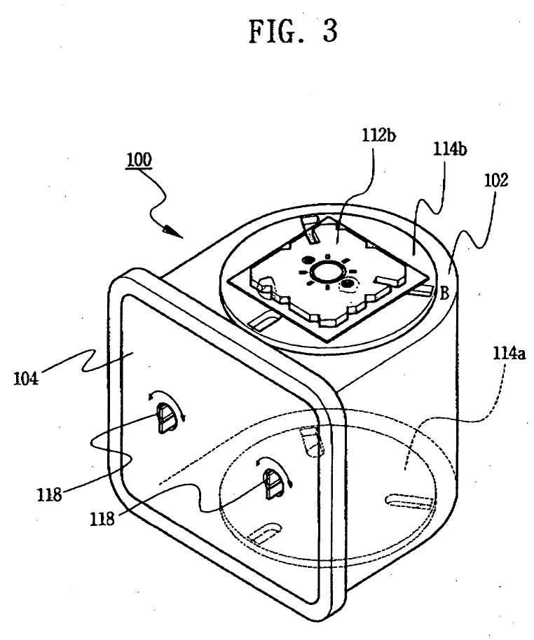

Referring first to FIGS. 2 and 3, a FOUP 100 according to the present invention comprises a FOUP body 102 in which wafers W are held, and a FOUP door 104 for opening and closing the FOUP body 102. A slotted wafer support 106 for holding the wafers W is disposed inside the FOUP body 102. The FOUP body 102 may be made of transparent material so that the state of the wafers held by the wafer support 106 inside the FOUP body 102 can be easily checked. For example, the FOUP body 102 may be made of the transparent material such as plastics or tempered glass. The FOUP door 104 may be made of resin or metal. Foreign material is prevented from entering the FOUP body 102 when the FOUP door 104 is closed. The FOUP door 104 is attached to or detached from the FOUP body 102 by a door switch disposed in a load port of semiconductor device fabrication equipment.

More specifically, the FOUP body 102 has a frame 108 serving as a doorway to which the FOUP door 104 is secured. Thus, the wafers W pass through the opening delimited by the frame 108 into or out of the FOUP body 102 when the FOUP door 104 is open (FIG. 2). On the other hand, a packing extends along the edge of the FOUP door 104 to create a seal with the frame 108 when the FOUP door 104 is closed (FIG. 3).

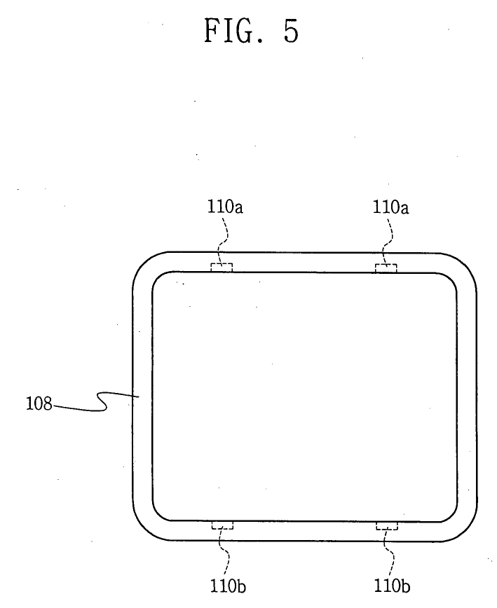

Referring also now to FIG. 5, first door locking openings 110a and second door locking openings 110b are defined in upper and lower segments of the frame 108, respectively. First door locking members 116a and second door locking members 116b are supported in the FOUP door 104 so as to be insertable into the first door locking openings 110a and the second door locking openings 110b, respectively.

Although FIGS. 2 and 5 illustrate two first door locking openings 110a (and two first door locking members 116a), and two second door locking openings 110b (and two second door locking members 116b), the present invention is not so limited. Rather, the upper segment of the frame 108 of the FOUP body 102 may have only one first door locking opening 110a, the lower segment of the frame 108 may have only one second door locking opening 110b, and only one first door locking member 116a and second door locking member 116b may be disposed within the FOUP door 104. However, two or more first door locking openings, two or more second door locking openings, and two or more first and second door locking members are preferable to ensure that the FOUP door 104 is stably secured against the FOUP body 102.

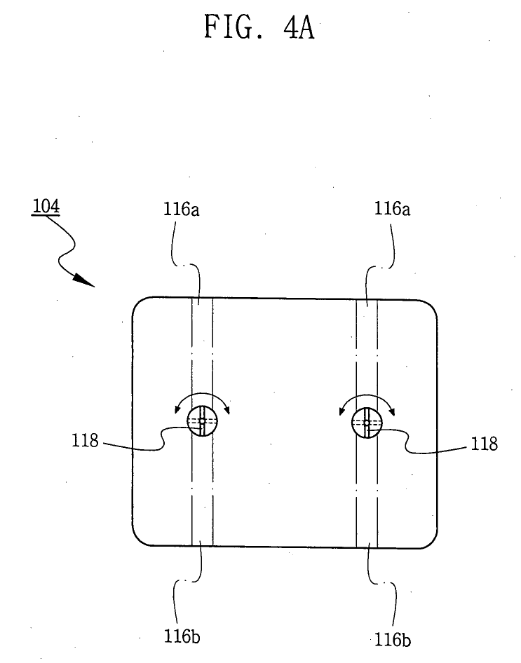

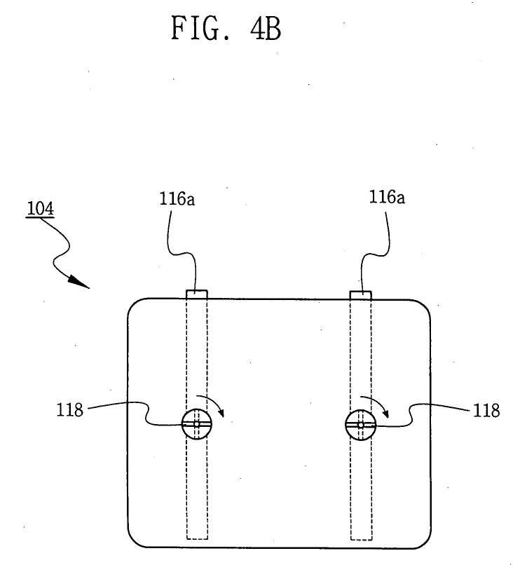

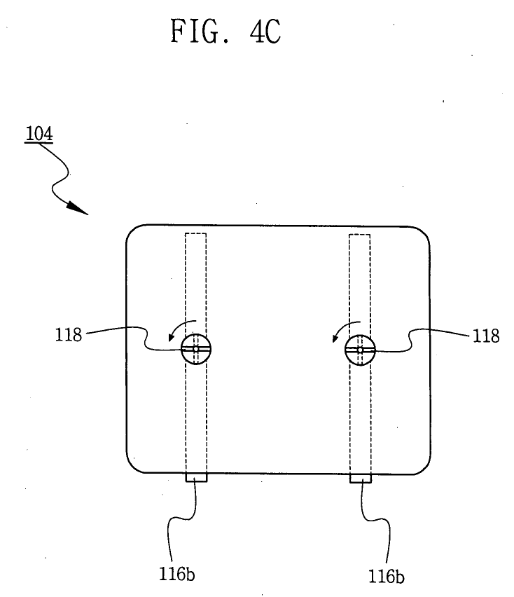

A pair of key assemblies 118 is also housed in the body of the FOUP door 104. Each of the key assemblies 118 can be rotated in each of opposite directions over a range of 0˜360 degrees. Each key assembly 118 is connected to a pair of first and second door locking members 116a and 116b so as to move the first and second door locking members 116a and 116b linearly in opposite directions when the key assembly 118 is rotated. Various suitable mechanisms can be used to operatively connect the key assembly 118 to a pair of first and second door locking members 116a and 116b such that rotation of the key assembly 118 moves the door locking members 116a and 116b. Therefore, this operative connection will be shown schematically, and will be described in more detail later on with reference to FIGS. 4A-4C.

Referring still to FIGS. 2 and 3, a first graspable member 112a and a second graspable member 112b (FIG. 3) are disposed on the top and bottom of the FOUP body 102, respectively. The graspable members 112a and 112b each comprise plates or the like configured to allow a PGV, OHT, OHC or AGV to grasp the same and thereby transfer the FOUP 100. In particular, slots in the edges of the graspable members 112a and 112b allow either of the graspable members 112a and 112b to be grasped at their edges and picked up by a PGV, OHT, OHC or AGV. Preferably, therefore, the first and second graspable members 112a and 112b have identical structural configurations. Furthermore, a first support member 114a and a second support member 114b (FIG. 3) are disposed on the top and bottom of the FOUP body 102, respectively. Either of the support members 114a, 114b can be received on a corresponding portion of the load port to stably the FOUP 100 on the load port. Therefore, the first and second support members 114a, 114b also preferably have substantially identical structural configurations. In particular, each support member 114a, 114b has a plurality of openings therein, such as recesses or pinholes, which receive complementary projections of the load port such that the FOUP is seated stably on the load port when the projections are inserted into the openings.

Thus, the FOUP 100 can be set on the load port irrespective of the top to bottom orientation of the FOUP 100. That is, the transfer system of the semiconductor device fabrication equipment can grasp the FOUP 100 at either the top or bottom thereof and transfer the FOUP 100 to the load port either top side up or bottom side up. Likewise, if the top of the FOUP 100 is that portion of the FOUP indicated by reference character “A” in FIG. 2, and the bottom of the FOUP 100 is that portion of the FOUP indicated by “B” in FIG. 3, the FOUP 100 can be stably supported on the load port with either the top or bottom facing upwardly. Accordingly, the wafers can be oriented with either of their major surfaces facing up prior to their introduction into the semiconductor device fabrication equipment. Therefore, practical applications of the semiconductor device fabrication equipment are maximized, the procurement costs of the equipment are minimized, and the loss of wafers is minimized.

FIGS. 4A through 4C are front views of the FOUP door 104 of the FOUP 100 in accordance with an embodiment of the present invention.

As illustrated in FIG. 4A, each pair of door locking members 116a and 116b are integral parts of a single elongated bar. Also, the door locking members 116a and 116b are located within the body of the FOUP door 104 when the key assemblies are in neutral positions shown in the figure. The key assemblies 118 can be rotated in either direction from the neutral positions as indicated by the double-headed arrows.

As illustrated in FIG. 4B, the first door locking members 116a are extended from the FOUP door 104 (so that the members 116a can be inserted into the first door locking openings 110a, respectively) when the key assemblies 118 are rotated 90 degrees in one direction from the neutral positions, e.g., clockwise. Also, the second door locking members 116b are retracted further into the FOUP door 104. In this case, the FOUP door 104 is secured to the FOUP body 102 by only the first door locking members 116a. Obviously, the key assemblies 118 need to be rotated by 90 degrees in the opposite direction, e.g., counter-clockwise, to detach the FOUP door 104 from the FOUP body 102 when the first door locking members 116a are securing the FOUP door 104 to the FOUP body 102.

As illustrated in FIG. 4C, the second door locking members 116b are extended from the FOUP door 104 (so that the members 116b can be inserted into the first door locking openings 110b, respectively) when the key assemblies 118 are rotated 90 degrees in one direction from the neutral positions, e.g., counter-clockwise. Also, the first door locking members 116a are retracted further into the FOUP door 104. In this case, the FOUP door 104 is secured to the FOUP body 102 by only the second door locking members 116b. Obviously, the key assemblies 118 need to be rotated by 90 degrees in the opposite direction, e.g., clockwise, to detach the FOUP door 104 from the FOUP body 102 when the second door locking members 116b are securing the FOUP door 104 to the FOUP body 102.

As described above, in accordance with the present invention, the key assemblies 118 of the FOUP door 104 are capable of rotating clockwise and counter-clockwise. Accordingly, the FOUP body 102 and the FOUP door 104 can be attached to or detached from each other irrespective of the top to bottom orientation of the FOUP 100 on the load port, i.e., irrespective of whether the top “A” or bottom “B” of the FOUP body 102 is facing upward.

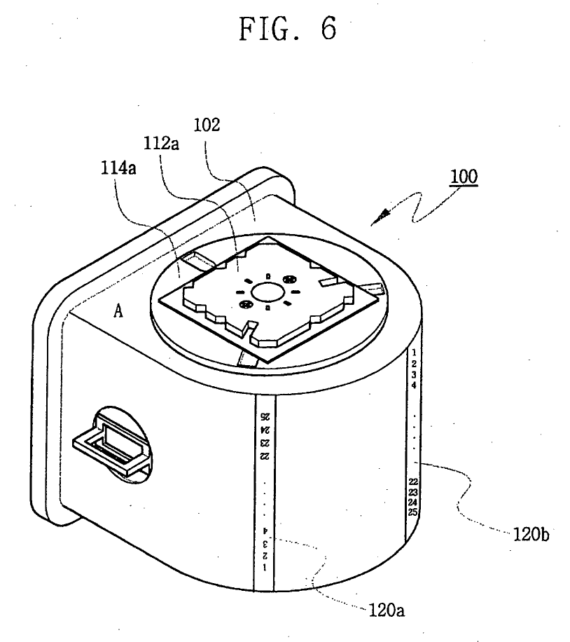

Referring now to FIG. 6, slot indicators 120a, 120b (FIG. 6) for indicating the locations of the slots of the wafer support 106 inside the FOUP body 102 are disposed on the outside of the FOUP body 102 at both sides of the rear portion of the FOUP body 102. More specifically, a respective slot indicator 120a, 120b is located at each corner between the rear of the FOUP body 102 and a respective side of the FOUP body 102. Alternatively, the slot indicators 120a, 120b may be disposed on both sides of the FOUP body 102 or at any other areas that are easily visually accessible.

Each slot indicator 120a, 120b has a series of numbers, e.g., 1-25, in numerical order wherein the highest number corresponds to the total number of slots of the wafer support 106 and the numbers are located at a positions corresponding to those of the slots of the wafer support 106, respectively. The numerical order in which the numbers of the slot indicator 120a are arranged and the numerical order in which the numbers of the slot indicator 120b are arranged run in opposite directions from top to bottom. Thus, the locations of the slots of the wafer support 106 inside the FOUP body 102 can be easily determined irrespective of the top to bottom orientation of the FOUP 100 on the load port, i.e., irrespective of whether the top “A” or bottom “B” of the FOUP body 102 is facing upward.

As described above, the FOUP 100 according to the present invention has the following features:
\textcircled{1} first and second door locking openings 110a and 110b defined in upper and lower portions of the frame 108 of the FOUP body 102, and first and second door locking members 116a and 116b supported in the FOUP door 104;
\textcircled{2} first and second graspable members 112a and 112b respectively disposed at the top and bottom of the FOUP body 102, and each of which can be grasped by a transfer system (passive or automatic) to allow the FOUP 100 to be transported with either the top or bottom thereof facing up;
\textcircled{3} first and second support members 114a and 114b respectively disposed at the top and bottom of the FOUP body 102, and each of which allows the FOUP body 102 to be supported stably on a load port of semiconductor device fabrication equipment;
\textcircled{4} (one or more key assemblies 118 each of which is operatively connected to first and second door locking members 116a and 116b and can be rotated clockwise and counter-clockwise to selectively insert the first and second door locking members 116a and 116b into the first and second door locking openings 110a and 110b, respectively (or to selectively withdraw the first and second door locking members 116a and 116b from the first and second door locking openings 110a and 110b, respectively); and
\textcircled{5} slot indicators 120a, 120b indicating the locations of the slots of the wafer support 106 inside the FOUP body 102 and one of which has characters (e.g., numerical) that are oriented right side up when the top of the FOUP is facing upwardly and the other of which has characters (e.g., numerical) that are oriented right side up when the bottom of the FOUP is facing upwardly.

Thus, as also described above, the FOUP 100 can be transported and set on the load port with either side of the FOUP 100 (top or bottom) facing upwardly. Also, the FOUP 100 can be stably supported on the load port either top side up or bottom side up. Still further, the same mechanism can attach the FOUP door 104 to and detach the FOUP door 104 from the FOUP body 102, or can remove the FOUP door 104 from and place the FOUP door 104 over the FOUP body 102, irrespective of the orientation of the FOUP 100. Finally, the locations of the slots of the wafer support 106 can be easily visually determined from outside the FOUP 100 irrespective of whether the top or bottom of the FOUP 100 is facing upwardly. Accordingly, the wafers can be oriented in a standby state in semiconductor device fabrication equipment with either of their major surfaces facing up. Therefore, practical applications of the semiconductor device fabrication equipment are maximized, the procurement costs of the equipment are minimized, and the loss of wafers is minimized.

Finally, although the present invention has been described in connection with the preferred embodiments thereof, it is to be understood that the scope of the present invention is not so limited. On the contrary, various modifications of and changes to the preferred embodiments will be apparent to those of ordinary skill in the art. Thus, changes to and modifications of the preferred embodiments may fall within the true spirit and scope of the invention as defined by the appended claims.

What is claimed is:

1. A FOUP (front open unified pod) comprising:
a FOUP body defining an opening at one side thereof and through which substrates can pass into and out of the FOUP body, and door locking openings at the one side thereof, and the FOUP body having a top, a bottom, a first graspable member and a second graspable member disposed at the top and bottom of the FOUP body, respectively, and a first support member and a second support member disposed at the top and bottom of the FOUP body, respectively; and
a FOUP door fitted to the FOUP body at the open side thereof so as to cover the FOUP body, the FOUP door having a door body, at least one pair of first and second door locking members, and at least one key assembly operatively connected to the first and second door locking members and actuatable to selectively move the first and second door locking members into and out of the door locking openings of the FOUP body, respectively, to thereby attach and detach the FOUP door to and from the FOUP body.

2. The FOUP according to claim 1, wherein the door locking openings are defined in the FOUP body adjacent the top and bottom of the FOUP body, respectively, each said key assembly is operatively connected to a respective pair of the first and second door locking members, and the first and second door locking members of each said pair are selectively movable by a said key assembly into and out of first and second ones of the door locking openings, respectively, adjacent the top and bottom of the FOUP body.

3. The FOUP according to claim 2, wherein the FOUP body has a frame delimiting the opening in the FOUP body, and the first and second ones of the door locking openings are defined in upper and lower segments of the frame, respectively, the upper and lower segments being located adjacent the top and bottom of the FOUP body, respectively.

4. The FOUP according to claim 1, wherein each said at least one key assembly is supported in the body of the FOUP door so as to be rotatable, and the at least one key assembly is operatively connected to the first and second door locking members so as to slide the door locking members linearly when the at least one key assembly is rotated.

5. The FOUP according to claim 4, wherein the door locking openings are defined in the FOUP body adjacent the top and bottom of the FOUP body, respectively, each said key assembly is operatively connected to a respective pair of the first and second door locking members, and the first and second door locking members of each said pair are selectively movable by a said key assembly into and out of first and second ones of the door locking openings, respectively, adjacent the top and bottom of the FOUP body.

6. The FOUP according to claim 5, wherein the FOUP body has a frame delimiting the opening in the FOUP body, and the first and second ones of the door locking openings are defined in upper and segments of the frame, respectively, adjacent the top and bottom of the FOUP body.

7. The FOUP according to claim 1, wherein the first and second graspable members have substantially identical structural configurations.

8. The FOUP according to claim 1, wherein the first and second support members have substantially identical structural configurations.

9. The FOUP according to claim 1, wherein the FOUP body has a wafer support defining a plurality of slots inside the FOUP body, each of the slots being sized to accommodate a wafer, and first and second slot indicators on the outside of the FOUP body, each of the slot indicators comprising a series of numbers arranged in numerical order wherein the highest number corresponds to the total number of slots of the wafer support and the numbers are located at a positions corresponding to those of the slots of the wafer support, respectively, and wherein the numerical order in which the numbers of one of the slot indicators are arranged and the numerical order in which the numbers of the other of the slot indicators are arranged run in opposite directions between the top and bottom of the FOUP body.

10. In combination with semiconductor device fabrication equipment having a load port at which semiconductor substrates stand by before and/or after being processed in the equipment, and a transfer system for transporting the substrates to the load port, a FOUP comprising:
a FOUP body defining an opening at one side thereof and through which substrates can pass into and out of the FOUP body, and door locking openings at the one side thereof, and the FOUP body having a top, a bottom, a first graspable member and a second graspable member disposed at the top and bottom of the FOUP body, respectively, and a first support member and a second support member disposed at the top and bottom of the FOUP body, respectively,
each of the graspable members is configured to allow the transfer system to grasp the same and thereby transfer the FOUP, whereby the FOUP can be transported by the transfer system with either the top or the bottom of the FOUP body facing upwardly, and
each of the support members can be fitted to a portion of the load port, whereby the FOUP can be stably supported on the load port with either the top or the bottom of the FOUP body facing upwardly; and
a FOUP door fitted to the FOUP body at the open side thereof so as to cover the FOUP body, the FOUP door having a door body, at least one pair of first and second door locking members, and at least one key assembly operatively connected to the first and second door locking members and actuatable to selectively move the first and second door locking members into and out of the door locking openings of the FOUP body, respectively, to thereby attach and detach the FOUP door to and from the FOUP body.

11. The combination according to claim 1, wherein the door locking openings are defined in the FOUP body adjacent the top and bottom of the FOUP body, respectively, each said key assembly is operatively connected to a respective pair of the first and second door locking members, and the first and second door locking members of each said pair are selectively movable by a said key assembly into and out of first and second ones of the door locking openings, respectively, adjacent the top and bottom of the FOUP body.

12. The combination according to claim 11, wherein the FOUP body has a frame delimiting the opening in the FOUP body, and the first and second ones of the door locking openings are defined in upper and lower segments of the frame, respectively, the upper and lower segments being located adjacent the top and bottom of the FOUP body, respectively.

13. The combination according to claim 10, wherein each said at least one key assembly is supported in the body of the FOUP door so as to be rotatable, and the at least one key assembly is operatively connected to the first and second door locking members so as to slide the door locking members linearly when the at least one key assembly is rotated.

14. The combination according to claim 13, wherein the door locking openings are defined in the FOUP body adjacent the top and bottom of the FOUP body, respectively, each said key assembly is operatively connected to a respective pair of the first and second door locking members, and the first and second door locking members of each said pair are selectively movable by a said key assembly into and out of first and second ones of the door locking openings, respectively, adjacent the top and bottom of the FOUP body.

15. The combination according to claim 14, wherein the FOUP body has a frame delimiting the opening in the FOUP body, and the first and second ones of the door locking openings are defined in upper and segments of the frame, respectively, adjacent the top and bottom of the FOUP body.

16. The combination according to claim 10, wherein the first and second graspable members have substantially identical structural configurations.

17. The FOUP according to claim 10, wherein the first and second support members have substantially identical structural configurations.

18. The FOUP according to claim 10, wherein the FOUP body has a wafer support defining a plurality of slots inside the FOUP body, each of the slots being sized to accommodate a wafer, and first and second slot indicators on the outside of the FOUP body, each of the slot indicators comprising a series of numbers arranged in numerical order wherein the highest number corresponds to the total number of slots of the wafer support and the numbers are located at a positions corresponding to those of the slots of the wafer support, respectively, and wherein the numerical order in which the numbers of one of the slot indicators are arranged and the numerical order in which the numbers of the other of the slot indicators are arranged run in opposite directions between the top and bottom of the FOUP body.
